(19) United States
(12) Patent Application Publication
(10) Pub. No.: US 2012/0312238 A1
(43) Pub. Date: Dec. 13, 2012

(54) Pet enclosure

(76) Inventor: Virginia Morales, Delran, NJ (US)

(21) Appl. No.: 13/134,557

(22) Filed: Jun. 11, 2011

(51) Int. Cl. A01K 1/035; A01K 29/00

(52) U.S. Cl. 119/28.5

(57) ABSTRACT

A pet enclosure is designed to create a pet resting space beneath a chair, between the seat portion of the chair and its supporting chair legs. The enclosure utilizes a curtain made of a pliable, flexible material having a length substantially equal to the perimeter of the seat portion of the chair and a width substantially equal to the distance between the seat portion and the bottom of the chair legs. The upper section of the curtain has a channel through which an elastic band extends. The curtain is positioned such that the elastic band is located around the lower region of the seat portion, such that the curtain extends down and circumscribes the seat portion. This creates an enclosed space beneath the seat portion. A pillow or similar resting surface is placed within the enclosed space on which the pet can position itself.

### BACKGROUND OF THE INVENTION

It is the habit of domestic pets, especially cats, to seek out and occupy enclosed spaces in which they feel secure. Many a pet owner searching for his or her pet is often surprised to discover some of the unexpected places the animal has taken up residence. While such discoveries are usually a source of amusement, sometimes the pet will locate itself in areas in which the owner prefers to remain pet-free, e.g. in closet spaces, on tops of beds or chairs, behind heating equipment, etc.

There are numerous pet houses and similar structural units providing alternate options in which a pet can seek shelter. However, these are usually permanent enclosures which are sometimes heavy, often cumbersome, and, for the most part, have limited portability. There is no effective pet enclosure which the pet owner can easily and, in fact, almost instantly create, in virtually any living space. There is no such enclosure which is also simple in design and use, and which is lightweight and readily portable.

### SUMMARY OF THE INVENTION

It is thus the object of the present invention to provide a pet enclosure which addresses the disadvantages and limitations of existing pet enclosures.

It is the object of the present invention to provide a pet enclosure which the pet owner can position around most any chair in order to quickly and readily create a secure and comfortable space for his or her pet.

It is a further object of the present invention to provide a pet enclosure which has relatively few components, is easily and economically fabricated, and is lightweight and portable.

These and other objects are accomplished by the present invention, a pet enclosure which is designed to create a pet resting space beneath a chair, between the seat portion of the chair and its supporting chair legs. The enclosure utilizes a curtain made of a pliable, flexible material having a length substantially equal to the perimeter of the seat portion of the chair and a width substantially equal to the distance between the seat portion and the bottom of the chair legs. The upper section of the curtain has a channel through which an elastic band extends. The curtain is positioned such that the elastic band is located around the lower region of the seat portion, such that the curtain extends down and circumscribes the seat portion. This creates an enclosed space beneath the seat portion. A pillow or similar resting surface is placed within the enclosed space on which the pet can position itself.

The novel features which are considered as characteristic of the invention are set forth in particular in the appended claims. The invention, itself, however, both as to its design, construction and use, together with additional features and advantages thereof, are best understood upon review of the following detailed description with reference to the accompanying drawings.

### BRIEF DESCRIPTION OF THE DRAWINGS

FIG. 1 shows the pet enclosure of the present invention in use around a chair.

FIG. 2 shows the pet enclosure of the present invention housing a pet.

FIG. 3 is an isometric view of the pet enclosure curtain of the present invention.

### DETAILED DESCRIPTION OF THE INVENTION

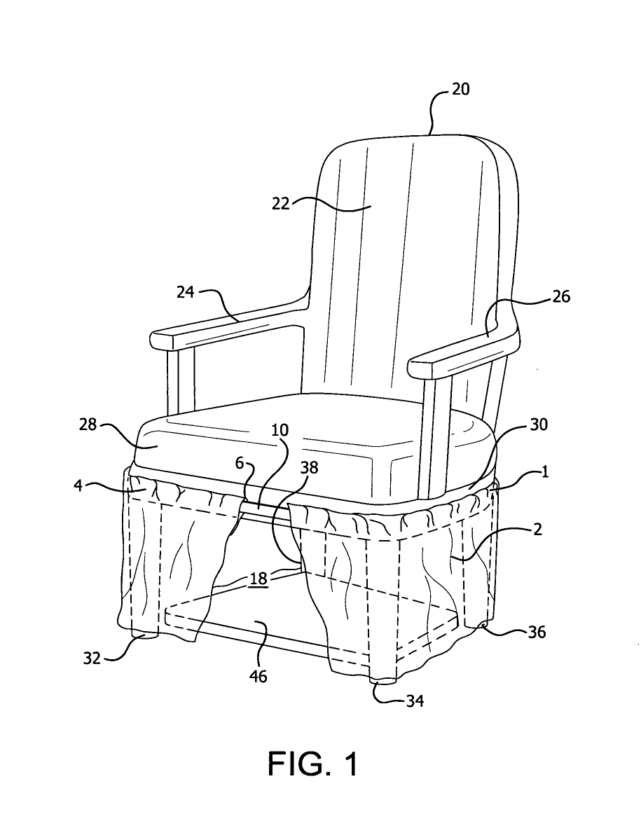

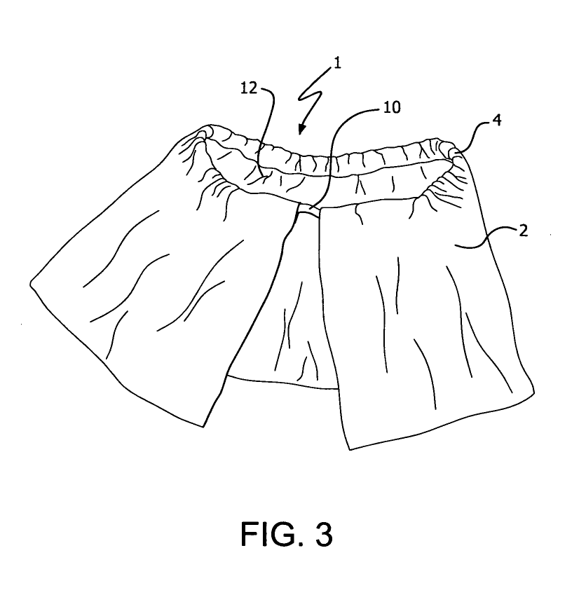

Curtain 1 of the pet enclosure of the present invention comprises an extended length of pliable, flexible material 2. Curtain 1 has upper section 4 through which enclosed channel 6 extends. Channel 6, extending the full length of curtain 1, is formed within the folded over top end of material 2, which is sewn or otherwise attached to the main body of the material, as best seen in FIG. 1. Continuous, expandable elastic band 10 is located within channel 6. In its resting, contracted position, shown in FIG. 3, elastic band 1 reduces the perimeter of upper section 4 of curtain 1, surrounding opening 12 at the top end of the curtain. It can be appreciated that when elastic band 10 is stretched, opening 12 becomes substantially larger.

Although the dimensions of curtain 1 are not to be considered restricted, the length of material 2 should be approximately equal to the perimeter of the seat portion of the chair around which the curtain is to be placed and its width should be substantially equal to the distance between the lower region of the seat portion and the bottom of the legs of the chair.

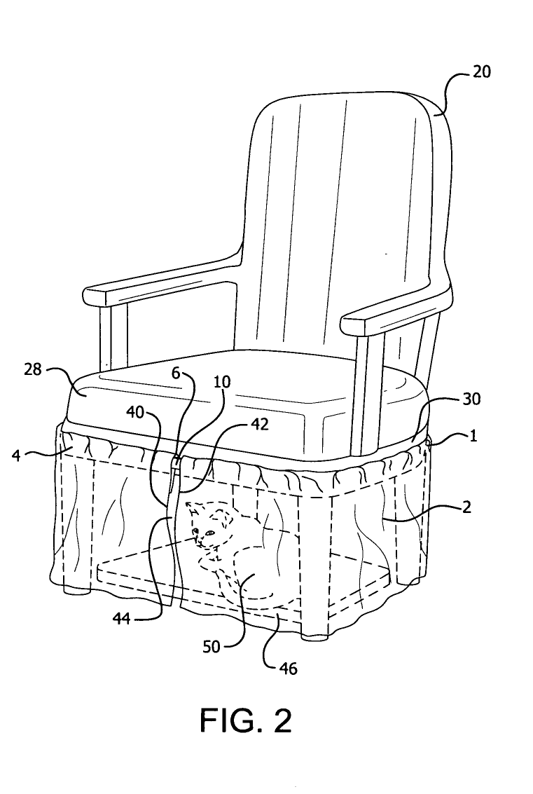

In use, elastic band 10 of curtain 1 is stretched to allow the curtain to be placed over seat back 22, hand rails 24 and 26 and seat portion 28 of chair 20. Elastic band 10 is then positioned around lower region 30 of seat portion 28, such that material 2 of curtain 1 extends from the lower region to the bottom of chair legs 32, 34, 36 and 38. Elastic band 10 resiliently maintains curtain 1 over lower region 30 of seat portion 28. As seen in FIG. 2, vertical end edges 40 and 42 of material 2 are then drawn together to form slit opening 44. This results in curtain 1 circumscribing enclosed space 18 beneath seat portion 28, slit opening 44 providing pet ingress into and egress from enclosed space 18. Pillow or other comfortable pet seating component 46 is positioned under seat portion 28, such that pet 50 can comfortably sit or lay beneath the chair, within enclosed space 18.

The pet enclosure of the present invention thus allows the pet owner to almost instantly and quite easily create an enclosed space in which his or her pet can position itself, under virtually any type of chair. Curtain 1 and its pillow 46 is not only versatile in that it can be used with a variety of different chairs, it is also easily removed from the chair, and is readily portable for use on different chairs in other locations.

Certain novel features and components of this invention are disclosed in detail in order to make the invention clear in at least one form thereof. However, it is to be clearly understood that the invention as disclosed is not necessarily limited to the exact form and details as disclosed, since it is apparent that various modifications and changes may be made without departing from the spirit of the invention.

1. A pet enclosure for the creation of a pet resting space beneath a chair having a seat portion with a given diameter and downwardly extending chair legs, said enclosure comprising:
a curtain of pliable, flexible material having a length substantially equal to the perimeter of the seat portion and a width substantially equal to the distance between the seat portion and the bottom of the chair legs, vertical edges at the end of the length of the material, an upper section having a through channel extending the length of the material, and elastic means located within the channel for expanding the upper section of the curtain and for resiliently maintaining the curtain around the seat portion; and
a pet sitting pillow element, whereby placement of the upper section and the elastic means around the perimeter of the seat portion aligns the vertical edges adjacent to each other and creates an enclosed space beneath the seat portion and whereby placement of the pet sitting element beneath the chair provides a surface on which the pet positions itself within the enclosed space.

2. The pet enclosure as in claim 1 wherein the elastic means permits the curtain to be placed around chairs with seat portions of varying perimeters.

3. The pet enclosure as in claim 1 wherein when the vertical edges are aligned, they form a slit opening providing pet ingress into and egress from the enclosed space.

4. The pet enclosure as in claim 1 wherein the elastic means comprises an elastic band.
